(19) United States
(12) Patent Application Publication
(10) Pub. No.: US 2015/0358297 A1
(43) Pub. Date: Dec. 10, 2015

(54) SECURE PEER-TO-PEER DATA SYCHRONIZATION

(71) Applicant: Dropbox, Inc., San Francisco, CA (US)

(72) Inventors: Jesse Endahl, Oakland, CA (US); Anton Mityagin, San Francisco, CA (US)

(21) Appl. No.: 14/448,972

(22) Filed: Jul. 31, 2014

Related U.S. Application Data
(60) Provisional application No. 62/008,940, filed on Jun. 6, 2014.

(51) Int. Cl. H04L 29/06; H04L 9/14

(52) U.S. Cl. CPC H04L 63/0435; H04L 9/14; H04L 2209/24

(57) ABSTRACT

The disclosed embodiments relate to a feature of a content-item-uploading system that facilitates secure, peer-to-peer distributed sharing of a version of a content item by a user that created the version of the content item (e.g., by modifying a previous version of the content item or by creating a new content item). During operation, the system receives a cryptographic key from the user. In response, the system provides the cryptographic key to recipients in the system. Subsequently, the recipients can use the cryptographic key for secure, peer-to-peer distributed sharing of the version of the content item among the user and the recipients in a shared network without synchronization conflicts with previous versions of the content item in the system.

### CROSS-REFERENCE TO RELATED APPLICATION

This application claims priority under 35 U.S.C. §119(e) to U.S. Provisional Application Ser. No. 62/008,940, entitled “Secure Peer-to-Peer Data Synchronization,” by Jesse Endahl and Anton Mityagin, Attorney docket number DPBX-191USP1, filed on Jun. 6, 2014, the contents of which are herein incorporated by reference.

### BACKGROUND

1. Field

The disclosed embodiments generally relate to techniques for peer-to-peer distributed sharing of content items (such as files) in a network. More specifically, the disclosed embodiments relate to a system that facilitates peer-to-peer distributed sharing of a version of a content item in the network by providing a cryptographic key to recipients in the network via a synchronization computer.

2. Related Art

Users of an online content management system, such as the Dropbox™ service, provided by Dropbox, Inc., of San Francisco, Calif., often desire to share their files (and, more generally, content items) with other individuals. Peer-to-peer distributed sharing of the content items in such an online content management system can eliminate bottlenecks, thereby increasing the speed at which the content items can be shared among the individuals. In particular, in peer-to-peer distributed sharing, the individuals can directly transfer the content items from one computer or electronic device to another, instead of uploading and downloading the content items to and from remote storage in the online content management system.

However, synchronization conflicts can occur during peer-to-peer distributed sharing of a content item. For example, if an individual in the online content management system modifies and distributes the content item, this modified version of the content item will be different from the previous versions of the content item on the other electronic devices in the online content management system. Similar synchronization conflicts can occur when two individuals concurrently modify a content item. These synchronization conflicts make it difficult for the individuals to know whether a local copy of the content item is current, which may degrade the user's experience and, thus, may decrease the user's satisfaction with the online content management system.

### SUMMARY

The disclosed embodiments relate to a feature of a synchronized online content management system that facilitates peer-to-peer distributed sharing of a version of a content item by allowing a user that created the version of the content item (e.g., by modifying a previous version of the content item or by creating a new content item) to provide a cryptographic key (such as a one-way cryptographic hash function or a symmetric encryption key) to a server. For example, the server can be part of the synchronized online content management system (such as Dropbox™). In response, the server provides the cryptographic key to designated recipients (such as authorized recipients in a common entity, e.g., a company) in the synchronized online content management system. Subsequently, the recipients can use the cryptographic key during peer-to-peer distributed sharing of the version of the content item among the user and the recipients in a shared network (such as an intranet and/or the Internet) without synchronization conflicts with previous versions of the content item in the synchronized online content management system.

The peer-to-peer distributed sharing may not require uploading or downloading of the version of the content item to the server or the synchronized online content management system. However, dissemination of the version of the content item in the shared network can be accelerated by uploading or downloading the version of the content item (or segments of the version of the content item that are encrypted using the cryptographic key) to the server or the synchronized online content management system.

### BRIEF DESCRIPTION OF THE FIGURES

FIG. 1 illustrates a content management environment, which includes a synchronized online content management system, in accordance with the disclosed embodiments.

FIG. 2 illustrates the content management environment of FIG. 1 in accordance with the disclosed embodiments.

FIG. 3 illustrates a computer system in the content management environment of FIG. 1 in accordance with the disclosed embodiments.

FIG. 4 presents a flow chart illustrating a process for facilitating secure, peer-to-peer distributed sharing of a content item in accordance with the disclosed embodiments.

FIG. 5 presents a flow chart illustrating the process of FIG. 4 in accordance with the disclosed embodiments.

FIG. 6 illustrates a dashboard for an administrator in accordance with the disclosed embodiments.

Note that like reference numerals refer to corresponding parts throughout the drawings. Moreover, multiple instances of the same part are designated by a common prefix separated from an instance number by a dash.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Content Management Environment

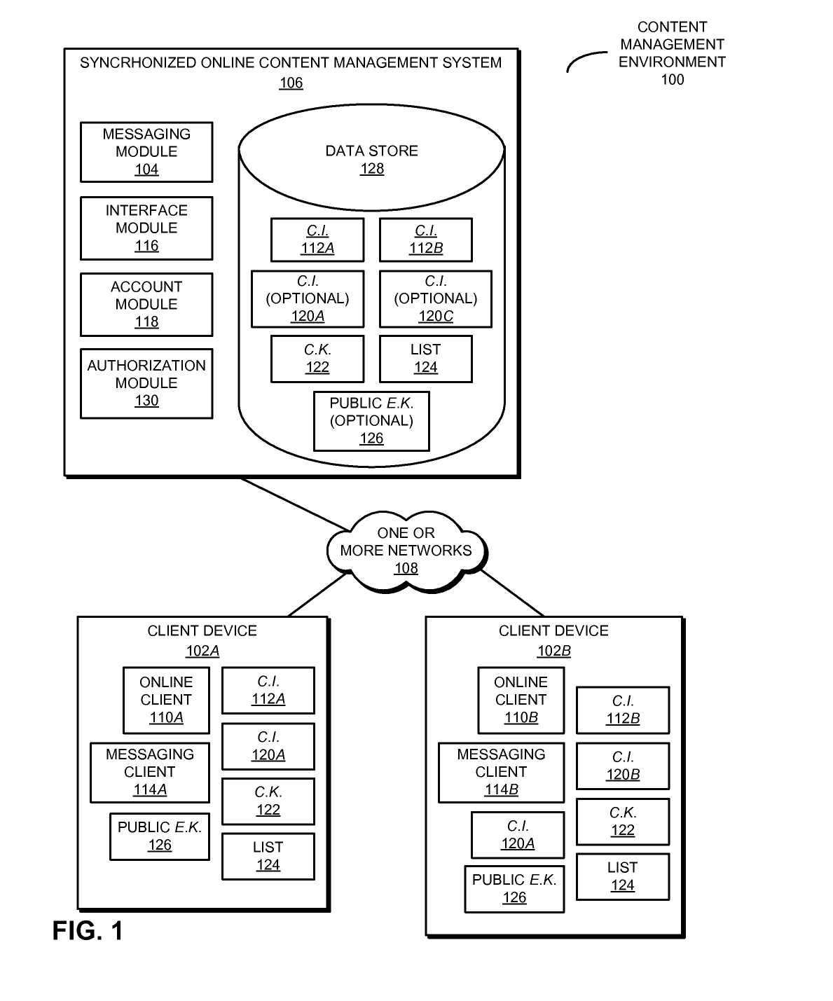

FIG. 1 shows content management environment 100 according to various embodiments. As may be understood from this figure, content management environment 100 includes a plurality of client devices 102A and 102E (collectively 102), and a synchronized online content management system 106 (also referred to as a “content management system”), which are all interconnected by one or more networks 108. Note that networks 108 may include: the Internet, World Wide Web (WWW), an intranet, a cellular-telephone network, LAN, WAN, MAN, or a combination of networks, or other technology enabling communication between computing systems. Various aspects of the client devices 102 and content management system 106 are discussed below.

Client Devices

In various embodiments, each client device 102 may selectively execute an online-service client application 110A and 110E (collectively 110) (also referred to as an “online client”), which may be used to manage content items (which may include files, such as audio, video, music, word-processor or data files and/or types of content or data having one or more formats, folders or containers that include multiple files or types of content, etc.) stored within a content management system 106. Noted that, in some embodiments, synchronized copies of content items (C.I.) 112A and 112E may be kept on content management system 106 and each respective client device 102. In some embodiments, client devices 102 may provide a file-browser type interface (not shown) for directly manipulating the content items stored on content management system 106 without maintaining a local copy.

Furthermore, client devices 102 may store unsynchronized copies of content items (C.I.) 120, such as different versions of one or more content items. These content items may or may not be stored on content management system 106. For example, a user of client device 102A may modify a previous version of a content item or may create content item 120A. This version of the content item may be different from other versions of this content item in content management environment 100, such as content item 120E on client device 102E and/or optional content item 120C on content management system 106.

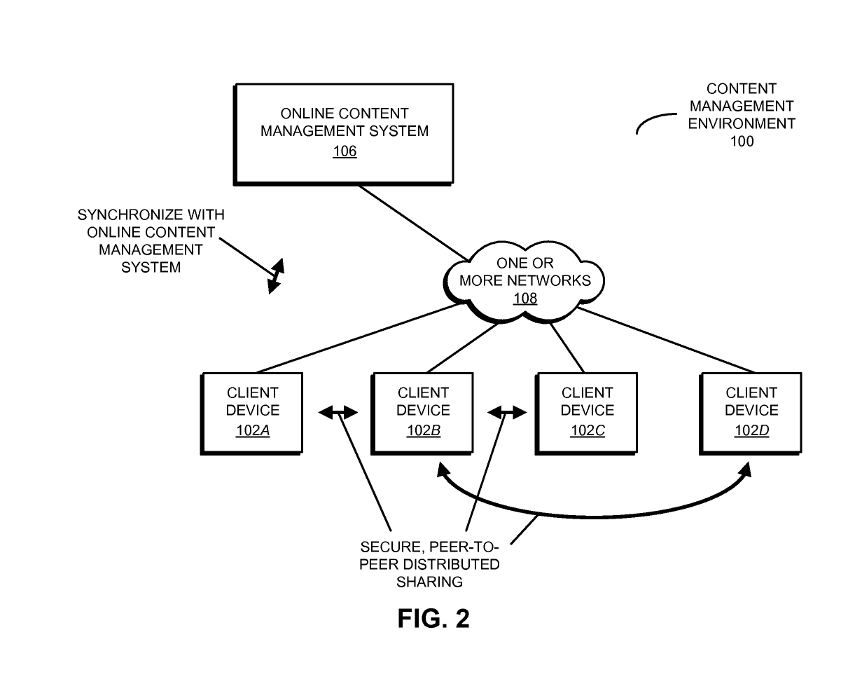

Online-service client applications 110 may also support secure, peer-to-peer distributed sharing of content items among client devices 102 via the one or more networks 108. In particular, recipients among client devices 102 in a shared network (such as one or more networks 108) may receive content item 120A from client device 102A, and then may provide content item 120A to other recipients among client devices 102. (Note that the recipients may be specified by a predefined list 124 of recipients on at least a subset of client devices 102, which specifies the recipients.) These transfers of content item 120A may or may not be mediated by content management system 106. As shown in FIG. 2, which illustrates content management environment 100, the transfers of content item 120A (or segments of content item 120A, if content item 120A is transferred piecewise) may occur directly between client devices 102, and/or may, at least in part, occur indirectly by transfer from client device 102A to content management system 106, and then from content management system 106 to the recipients. The distributed sharing or transfer of content item 120A in content management environment 100 may remove bottlenecks and may improve performance. For example, the secure distributed sharing may accelerate the transfer of content item 120A among client devices 102 while content item 120A is being synchronized with content management system 106.

In order to ensure that the sharing or transfers of content item 120A (or segments of content item 120A) are secure, content item 120A (or segments of content item 120A) may be encrypted. For example, when the previous version is modified or when content item 120A is created, online-service client application 110A may generate cryptographic key (C.K.) 122 (such as a one-way cryptographic hash function or a symmetric encryption key) or select a predetermined cryptographic key 122 for content item 120A, and cryptographic key 122 may be used to subsequently encrypt content item 120A (or segments of content item 120A), e.g., on the fly or dynamically when content item 120A is shared. However, in order to be able to decrypt an encrypted form of content item 120A (or encrypted segments of content item 120A), the recipients in content management environment 100 need to know which cryptographic key was used in the encryption, or need to have access to cryptographic key 122. In addition, peer-to-peer distributed sharing of content item 120A among client devices 102 can result in synchronization conflicts with previous versions of this content item in content management environment 100 (such as content item 120B and/or optional content item 120C).

These challenges may be addressed in content management environment 100 by using content management system 106 to rapidly disseminate cryptographic key 122 to the recipients, thereby ensuring the ability to decrypt the encrypted form of content item 120A and to ensure synchronization. In particular, online-service client application 110A may provide cryptographic key 122 to content management system 106 via network(s) 108, and content management system 106 may provide cryptographic key 122 to the recipients in content management environment 100 via network(s) 108. For example, content management system 106 may access predefined list 124 of the recipients (such as multiple devices associated with a common user account, user accounts associated with a shared content item, and/or recipients in a common entity, e.g., an organization, a company, an educational institution, etc.), and may provide cryptographic key 122 to the recipients specified in predefined list 124. When a client device, such as client device 102B, receives cryptographic key 122 associated with content item 120A, online-service client application 110E may be alerted that other versions of this content item (such as content item 120B) are outdated. Alternatively, after receiving content item 120A, a recipient may request cryptographic key 122 from content management system 106, which then provides cryptographic key 122 to the recipient. In these ways, content management environment 100 may offer the benefits of centralized dissemination of version and encryption information with those of distributed sharing. Furthermore, because cryptographic key 122 may be specific to content item 120A or one or more segments of content item 120A (and, thus, may be different from cryptographic keys associated with previous or later versions of the content item), this communication technique may prevent conflicts occurring between different versions of content item 120A that are being distributed among client devices 102 using secure peer-to-peer distributed sharing.

In addition to restricting access to cryptographic key 122 based on predefined list 124, online-service client applications 110 may support recipient-specific encryption. In particular, online-service client application 110A may encrypt multiple versions of cryptographic key 122 using public encryption keys 126 of the recipients (which may be specified in predefined list 124). These encrypted encryption keys may be provided to content management system 106 for subsequent distribution to the recipients (either automatically based on predefined list 124 or in response to requests from the recipients). Thus, a particular recipient may receive an encrypted cryptographic key 122 that was encrypted using the recipient's public encryption key. Then, this recipient can decrypt the encrypted cryptographic key 122 using their private encryption key, which will allow the recipient to decrypt content item 120A (or one or more segments of content item 120A) using the decrypted cryptographic key 122. Note that content management system 106 may or may not have access to the private encryption keys of the recipients and, thus, may or may not be able to decrypt encrypted cryptographic key 122 or encrypted content item 120A.

In some embodiments, prior to the secure peer-to-peer distributed sharing of content item 120A, predefined list 124 and/or public encryption keys 126 may be provided to at least the subset of client devices 102 by one of client devices 102 (such as client device 102A) that acts as an administrator for the common entity. For example, when a new recipient or member joins the common entity, the administrator may distribute a revised predefined list 124 and/or a public encryption key for the new recipient to at least the subset of client devices 102. This distribution may occur directly between client devices 102, and/or may, at least in part, occur indirectly by transfer from client device 102A to content management system 106, and then from content management system 106 to the recipients.

Client devices 102 may also include messaging clients 114A and 114E (collectively 114) for receiving and sending messages associated with messaging module 104. For example, the messages may include: text messages, emails, rich site summary (RSS) feeds, etc. Note that messaging clients 114A and 114E can be web-based or native-client-based messaging clients. Messaging client 114A may provide cryptographic key 122, while messaging client 114E may receive cryptographic key 122.

While only two client devices 102A and 102B are shown in FIG. 1, for purposes of clarity, it should be understood by those skilled in the relevant field that many client devices 102 may simultaneously connect through network(s) 108 to content management system 106 at any given time. Examples of suitable client devices 102 include, but are not limited to, a personal or desktop computer, a mobile computing device (such as a laptop, a subnotebook/netbook, a personal digital assistant, or a tablet computer), or a portable electronic device (such as a cellular phone or a smartphone, e.g., an iPhone®, BlackBerry®, or Android™-based smartphone). As discussed previously, each client device 102 may store a local, synced copy of one or more content items from within content management system 106, and the content items may be stored in any suitable content-item format. When one of online-service client applications 110 presents content items that are stored within the content-item storage system to a user, the content items may be arranged in folders (or containers) and the folders themselves may be arranged in other folders, or in any other arbitrary arrangement supported by content management system 106, as determined by the user. However, one of skill in the art should understand in light of this disclosure that each user's content-item-storage architecture may be considerably different from the next, and in some instances, the content-item-storage architecture may be implemented to maximize storage and content-item retrieval efficiency.

Content Management System

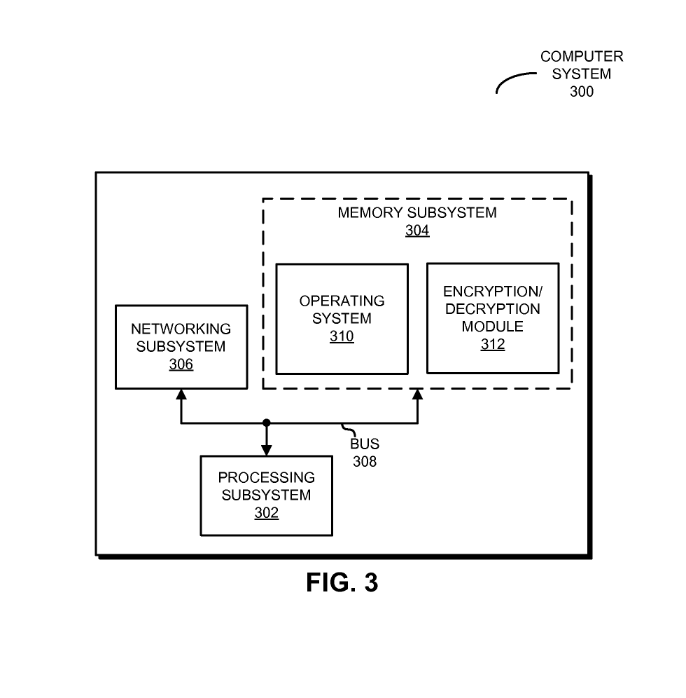

Content management system 106 stores content items and manages access to the content items via client devices 102. As described further below with reference to FIG. 3, content management system 106 and its components may be implemented using any appropriate hardware and software for content-item serving, storage, and retrieval functions. For example, content management system 106 may be implemented in the form of a single server or multiple servers.

In various embodiments, content management system 106 includes: messaging module 104, interface module 116, account module 118, data store 128 and authorization module 130. Each of these elements of content management system 106 is discussed below.

Content Management System—Messaging Module

Messaging module 104 may communicate information with client devices 102 and, in particular, with messaging clients 114. For example, messaging module 104 may receive cryptographic key 122 associated with content item 120A from client device 102A, and may provide cryptographic key 122 to the recipients.

Content Management System—Interface Module

In particular embodiments, interface module 116 may facilitate content-item access and content-item storage among content management system 106 and client devices 102. Interface module 116 may receive content items from and send content items to client devices 102 consistent with the user's preferences for sharing content items. Interface module 116 may act as the counterpart to a client-side content-item-explorer style user interface that allows a user to manipulate content items directly stored on content management system 106. In some embodiments, software operating on client devices 102 may integrate network-stored content items with the client's local content-item system to enable a user to manipulate network-stored content items through the same user interface (UI) used to manipulate content items on the local content-item system, e.g., via a file explorer, file finder or browser application. As an alternative or supplement to the client-side content-item-explorer interface, interface module 116 may provide a web interface for client devices 102 to access (e.g., via a suitable one of online-service client applications 110) and allow a user to manipulate content items stored within content management system 106. In this way, the user can directly manipulate content items stored within content management system 106.

As described previously, interface module 116 may receive the encrypted form of content item 120A (or the encrypted segments of content item 120A) from client device 102A, and may assist in disseminating the encrypted form of content item 120A (or the encrypted segments of content item 120A) to the recipients. Note that the secure, peer-to-peer distributed sharing of content item 120A among the recipients may occur in lieu of synchronization of content item 120A in content management environment 100 via content management system 106, or may supplement the synchronization of content item 120A in content management environment 100 via content management system 106.

Content Management System—Data Store

In various embodiments, data store 128 may store content items such as those uploaded using client devices 102, or using any other suitable computing device. In the embodiment illustrated in FIG. 1, client device 102A, which is associated with a first user, is shown as locally storing at least content item 112A, and client device 102B, which is associated with a second user, is shown as locally storing at least content item 112B. As shown in FIG. 1, copies of the locally stored content items are maintained in data store 128 of content management system 106.

In various embodiments, data store 128 may maintain information identifying the user, information describing the user's content-item directory, and other information in a content-item journal that is maintained for each user. In some embodiments, the content-item journal may be maintained on content management system 106, and in other embodiments, a content-item journal (e.g., a ‘server-side content-item journal’) may be maintained on content management system 106 and locally on each client device 102. In various embodiments, the content-item journal may be used to facilitate the synchronization of the various copies of a particular content item that are associated with a user's account.

As illustrated in FIG. 1, the system may be configured so that any changes that are made to content item 112A on particular client device 102A may also be automatically reflected in the copy of content item 112A stored within content management system 106 (subject to the delay, if any, associated with uploading content item 112A or the changes to content item 112A from client device 102A to content management system 106). Similarly, any changes that are made to content item 112A on content management system 106 may also be automatically reflected in the copy of content item 112A stored on client device 102A (subject to the delay, if any, associated with downloading content item 112A or the changes to content item 112A from content management system 106 to client device 102A).

Furthermore, as discussed previously, data store 128 may also include: cryptographic key 122, predefined list 124 of recipients, optional public encryption keys 126, previous version(s) of unsynchronized content items (such as optional content item 120C), and, optionally, content item 120A (or segments of content item 120A), which may be encrypted. This information may be used to facilitate the secure, peer-to-peer distributed sharing of content item 120A.

Content Management System—Account Module

In particular embodiments, account module 118 may track content items stored in data store 128 and entries in the server-side content-item journal for each content item. As users grant content-item access permissions to other users (e.g., by including users in predefined list 124 of recipients), account module 118 may update the server-side content-item journal associated with each relevant user in data store 128. Account module 118 may also track client devices 102 that are associated with each user's account. For example, a user may want to share all their content items among their desktop computer, tablet computer, and mobile device. To make such a sharing arrangement seamless to the user, the user's single account on content management system 106 may be associated with each of the user's respective client devices. In some embodiments, an application running on each respective client device 102 may help to coordinate synchronization of content items on the client device with corresponding versions of the content items within the user's account in content management system 106, and also with corresponding versions of the content items stored on the user's various other client devices.

Content Management System—Authorization Module

In various embodiments, after cryptographic key 122 is received, authorization module 130 accesses predefined list 124 of recipients. Then, messaging module 104 provides cryptographic key 122 to the specified recipients. Alternatively, messaging module 104 may receive requests for cryptographic key 122 from one or more client devices 102. In response, authorization module 130 accesses predefined list 124 of recipients to confirm that the one or more client devices 102 are included in the specified recipients prior to messaging module 104 providing cryptographic key 122.

### Computer System

FIG. 3 presents a block diagram of a computer system 300 in content management environment 100 in FIG. 1, such as content management system 106. This computer system includes processing subsystem 302, memory subsystem 304, and networking subsystem 306 all coupled together and communicating through bus 308.

Processing subsystem 302 includes one or more devices configured to perform computational operations. For example, processing subsystem 302 can include one or more microprocessors, application-specific integrated circuits (ASICs), microcontrollers, application processors, and/or programmable-logic devices.

Memory subsystem 304 includes one or more devices for storing data and/or instructions for processing subsystem 302, and networking subsystem 306. For example, memory subsystem 304 can include any type of computer-readable storage medium, such as dynamic random access memory (DRAM), static random access memory (SRAM), and/or other types of memory. In addition, memory subsystem 304 can include mechanisms for controlling access to the memory. In some embodiments, memory subsystem 304 includes a memory hierarchy that comprises one or more caches coupled to a memory in computer system 300. In some of these embodiments, one or more of the caches is located in processing subsystem 302. Memory subsystem 304 may store one or more program modules or computer-program mechanisms with instructions for operations that implement the secure, peer-to-peer distributed sharing of content items, which may be executed by processing subsystem 302, such as: messaging module 104, authorization module 130 in FIG. 1 and encryption/decryption module 312.

Moreover, memory subsystem 304 may store operating system 310 (as program code), which may be executed by processing subsystem 302. In general, operating system 310 serves as an intermediary between system hardware in computer system 300 and software applications executed by processing subsystem 302. For example, operating system 310 can be, but is not limited to, the iOS operating system or OS X® operating system, both from Apple Inc. of Cupertino, Calif.; Windows Phone from Microsoft Corporation of Redmond, Wash.; Android from the Open Handset Alliance of Mountain View, Calif.; the FreeBSD operating system from The FreeBSD Foundation of Boulder, Colo.; or another operating system. Operating systems and their general functions are known in the art and hence are not described in detail.

In order to manage the transfer of packets (such as the encrypted form of content item 120A or the encrypted segments of content item 120A in FIG. 1) to and from the software applications and operating system 310 in computer system 300 using an appropriate interface circuit or communication subsystem in networking subsystem 306, operating system 310 maintains one or more network or communication protocol stacks (not shown) that each includes a number of logical layers. For example, operating system 310 can maintain a cellular protocol stack and/or an Internet protocol stack, which includes the link, Internet, transport, and application layers. As another example, operating system 310 can maintain a protocol stack based on the OSI model, which includes: the application, presentation, session, transport, network, data-link, and physical layers. At corresponding layers of the protocol stack, operating system 310 includes control mechanisms and data structures for performing the functions associated with the layer. The secure, peer-to-peer distribution in FIG. 1 of the encrypted form of content item 120A (or the encrypted segments of content item 120A) may involve a cryptographic protocol between an application layer and a transport layer that uses cryptographic key 122. For example, the cryptographic protocol may include Secure Socket Layer (SSL). Alternatively or additionally, a transport-layer-security cryptographic protocol may be used.

Memory subsystem 304 may be coupled to one or more high-capacity mass-storage devices (not shown). For example, memory subsystem 304 can be coupled to a magnetic or optical drive, a solid-state drive, or another type of mass-storage device. Moreover, memory subsystem 304 can be used by computer system 300 as fast-access storage for often-used data, while the mass-storage device is used to store less frequently used data.

Networking subsystem 306 includes one or more devices (such as communication subsystems or chips) configured to couple to and communicate on a wired and/or wireless network (i.e., to perform network operations), such as one or more cellular packet data and cellular-telephone networks (e.g., 3G/4G networks), and WLAN networks, including portions based on standards described in IEEE 802.11 (such as a Wi-Fi networking system). Networking subsystem 306 can include a Bluetooth networking system, which may include Bluetooth low energy capabilities, a universal serial bus (USB) networking system, an Ethernet networking system, and/or another networking system. Networking subsystem 306 includes processors, controllers, radios/antennas, sockets/plugs, and/or other devices used for coupling to, communicating on, and handling data and events for each supported networking system.

Processing subsystem 302, memory subsystem 304, and networking subsystem 306 are coupled using bus 308. Bus 308 is an electrical, optical, or electro-optical connection that the subsystems can use to communicate commands and data among one another. Although only one bus 308 is shown for clarity, different embodiments can include a different number or configuration of electrical, optical, or electro-optical connections among the subsystems.

Although shown as separate subsystems in FIG. 3, in some embodiments, some or all of a given subsystem can be integrated into one or more of the other subsystems in computer system 300. Although alternative embodiments can be configured in this way, for clarity we describe the subsystems separately.

Computer system 300 can be (or can be included in) any device with at least one processing subsystem and one networking subsystem. For example, computer system 300 can be (or can be included in): a personal or desktop computer, a laptop computer, a mainframe computer, a subnotebook/netbook, a tablet computer, a network appliance, a server, and/or another computing device.

Computer system 300 may also include one or more additional processing subsystems 302, memory subsystems 304, and/or networking subsystems 306. Additionally, one or more of the subsystems may not be present in computer system 300. Furthermore, although we use specific subsystems to describe computer system 300, in alternative embodiments, computer system 300 may include one or more additional subsystems that are not shown in FIG. 3. For example, computer system 300 may also include, without limitation: a data collection subsystem, an alarm subsystem, an audio subsystem, a display subsystem and/or an input/output (I/O) subsystem. Moreover, computer system 300 may include a display subsystem which can include any type of display technology such as: a light-emitting diode (LED); an organic light-emitting diode (OLED); a liquid crystal display (LCD), such as thin film transistor (TFT); and/or other types of display technology. In addition, the display subsystem may include mechanisms for processing data, and/or other information for display and may also include an audio subsystem for producing sound.

### Secure, Peer-to-Peer Distributed Sharing Process

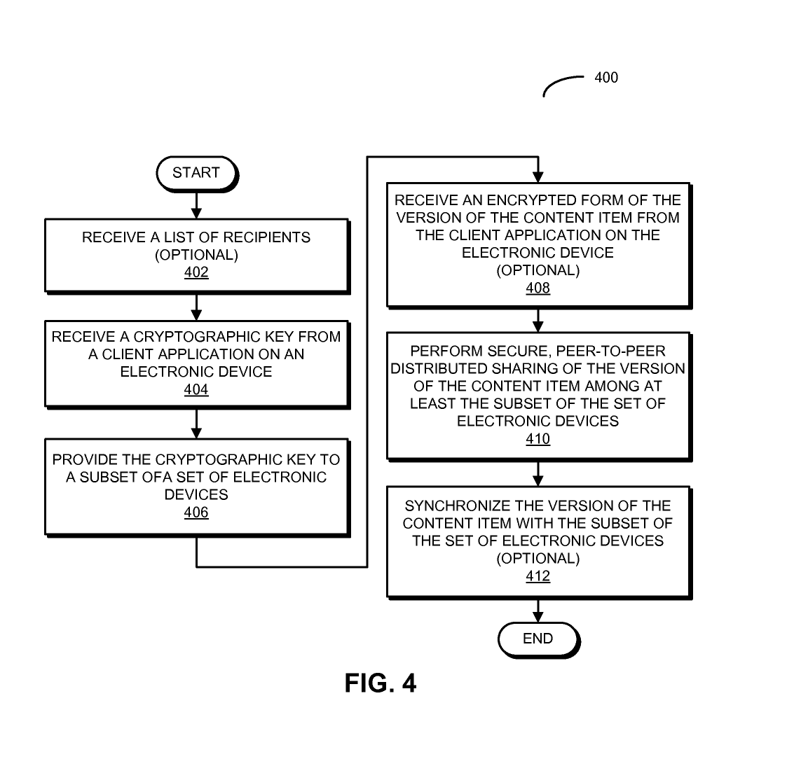

FIG. 4 presents a flow chart illustrating a process 400 for facilitating secure, peer-to-peer distributed sharing of a content item, which may be performed by a system. For example, process 400 may be performed by modules or components in content management system 106 in FIG. 1, including: messaging module 104 and authorization module 130. During operation, the system receives a cryptographic key from a client application on an electronic device (operation 404) in a set of electronic devices that communicate via a shared network, where the cryptographic key is associated with a version of the content item, and the version of the content item includes modified content relative to at least a previous version of the content item. For example, a user of client device 102A may modify a previous version of content item 120A or create content item 120A (such as a version of a document or software). Online-service client application 110A may create cryptographic key 122 (using a cryptographic technique) or select predetermined cryptographic key 122 associated with content item 120A. This cryptographic key may be used to encrypt content item 120A (or segments of content item 120A) so that subsequent sharing is secure, and online-service client application 110A may instruct content management system 106 to upload cryptographic key 122 in FIG. 1. Note that the content item may be a container that includes multiple content items, such as a collection, a folder, a playlist, an album, etc. In some embodiments, prior to providing the cryptographic key, online-service client application 110A encrypts multiple versions of the cryptographic key using public encryption keys of the recipients that are specified in predefined list 124, and these encrypted cryptographic keys are provided to the system in operation 404.

Then, the system provides the cryptographic key associated with the version of the content item to client applications on a subset of the electronic devices (operation 406), i.e., the recipients. For example, after messaging module 104 in content management system 106 in FIG. 1 receives cryptographic key 122, authorization module 130 may access predefined list 124 of the recipients, and messaging module 104 may provide cryptographic key 122 to the recipients. However, in other embodiments, cryptographic key 122 is provided to all of client devices 102 that share network(s) 108 (i.e., the recipients may not be restricted by predefined list 124). Alternatively, after the recipients receive the content item in operation 410, they may request cryptographic key 122 and, in response to these requests, the system may provide cryptographic key 122. By providing the cryptographic key, the system may facilitate the secure, peer-to-peer distributed sharing of the version of the content item among the subset without synchronization conflicts between the version of the content item and the previous version of the content item in the set of electronic devices because the different versions of the content item may be encrypted with different cryptographic keys. In particular, cryptographic key 122 may be used by client devices 102 of the recipients to perform encryption/decryption of content item 120A.

Note that the system may have optionally previously received predefined list 124 of recipients (operation 402) from an administrator for a common entity, such as: an organization, a company, an educational institution, etc. In particular, messaging module 104 in FIG. 1 may have received predefined list 124 of recipients from a messaging client on the administrator's client device (such as messaging client 114A on client device 102A).

Once the cryptographic key has been provided to the client applications (operations 406), the system may perform the secure, peer-to-peer distributed sharing of the version of the content item among at least the subset of the set of electronic devices (operation 410). For example, online-service client application 110A in client device 102A in FIG. 1 may share the encrypted form of content item 120A (or the encrypted segments of content item 120A) with online-service client applications 110 in other client devices 102, such as a subset of client devices 102 used by the recipients. During the sharing of the encrypted form of content item 120A (or the encrypted segments of content item 120A), online-service client application 110A in client device 102A may automatically sign the shared encrypted form of content item 120A (or the encrypted segments of content item 120A). Moreover, online-service client applications 110 in other client devices 102 may be programmed to trust online-service client application 110A in client device 102A.

In some embodiments, the secure, peer-to-peer distributed sharing of the version of the content item is supplemented using the synchronized online content management system. In particular, the system may optionally synchronize the version of the content item with the subset of the set of electronic devices (operation 412). Therefore, prior to the optional synchronization (operation 412), the system may optionally receive an encrypted form of the version of the content item (or encrypted segments of the version of the content item) from the client application on the electronic device (operation 408). Note that the system may or may not decrypt the version of the content item or the encrypted segments of the version of the content item. For example, online-service client application 110A in client device 102A in FIG. 1 may transfer the encrypted form of content item 120A (or the encrypted segments of content item 120A) to interface module 116 in content management system 106, and interface module 116 may provide the encrypted form of content item 120A (or the encrypted segments of content item 120A) to online-service client applications 110 in the other client devices 102, such as a subset of client devices 102 used by the recipients.

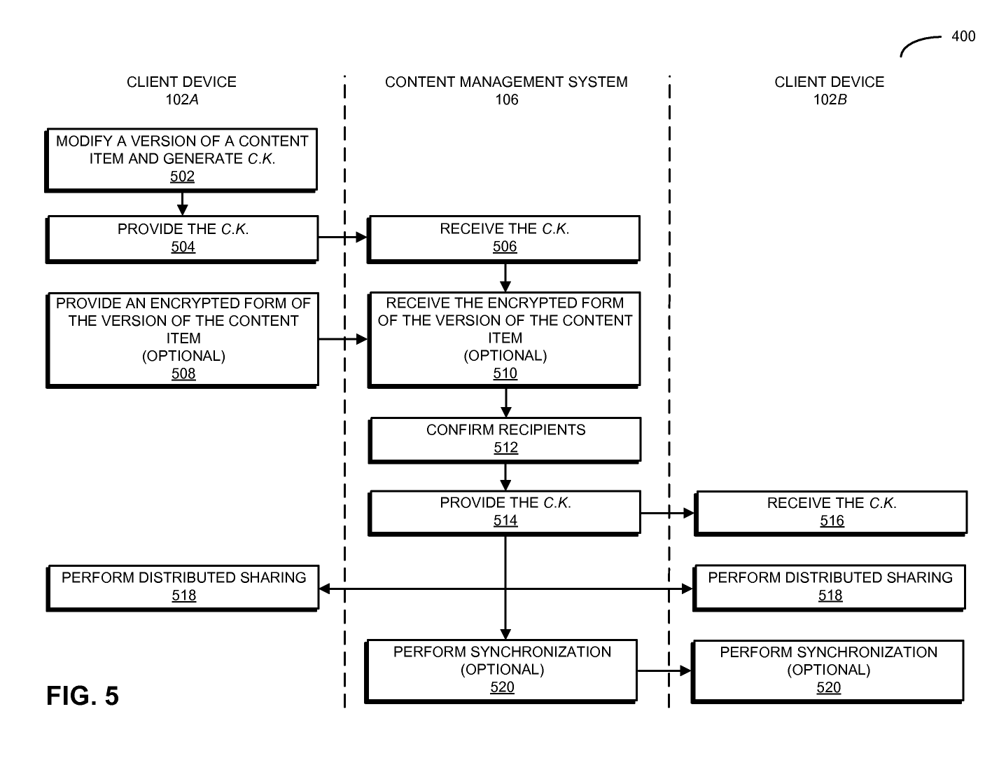

Process is further illustrated in FIG. 5, which shows the interaction among client device 102A, content management system 106 and client device 102B. For example, a user of client device 102A may modify (operation 502) or create the version of content item 120A. When this occurs, cryptographic key 122 associated with content item 120A may be generated or selected by online-service client application 110A. This cryptographic key may be used to encrypt content item 120A (or segments of content item 120A), and online-service client application 110A may instruct content management system 106 to upload cryptographic key 122. During the uploading, messaging client 114A in client device 102A may provide (operation 504) and messaging module 104 in content management system 106 may receive (operation 506) cryptographic key 122. Prior to providing the cryptographic key, online-service client application 110A may encrypt multiple versions of cryptographic key 122 using public encryption keys of the recipients, and these encrypted cryptographic keys are provided to and received by content management system 106 in operations 504 and 506.

If the secure, peer-to-peer distribution is facilitated, at least in part, by content management system 106, then online-service client application 110A in client device 102A may optionally provide (operation 508) and interface module 116 in content management system 106 may optionally receive (operation 510) the encrypted form of content item 120A (or the encrypted segments of content item 120A). In particular, content item 120A (or the segments of content item 120A) may be encrypted using cryptographic key 122.

Then, authorization module 130 in content management system 106 may confirm the recipients (operation 512) by accessing predefined list 124, which may have been previously provided by an administrator for a common entity and received by messaging module 104 in content management system 106.

Next, messaging module 104 in content management system 106 provides cryptographic key 122 (or encrypted versions of cryptographic key 122 that are encrypted using public encryption keys of the recipients) (operation 514), which are received (operation 516) by messaging clients 114 in at least a subset of client devices 102 used by the recipients. For example, messaging module 104 may provide cryptographic key 122 to messaging client 114E in client device 102B. (While not shown in FIG. 5, in some embodiments messaging module 104 in content management system 106 provides cryptographic key 122 (or encrypted versions of cryptographic key 122 that are encrypted using public encryption keys of the recipients) to at least the subset of client devices 102 used by the recipients in response to requests from at least the subset of client devices 102. For example, at least the subset of client devices 102 may provide the requests to messaging module 104 in content management system 106 after receiving the encrypted form of content item 120A in operation 518.)

Once cryptographic key 122 has been provided to client devices 102, online-service client applications 110 may perform secure, peer-to-peer distributed sharing of the encrypted form of content item 120A (operation 518) among at least the subset of client devices 102.

In some embodiments, interface module 116 in content management system 106 optionally performs synchronization (operation 520) of the encrypted form of content item 120A (or the encrypted segments of content item 120A) with online-service client applications 110 in the other client devices 102, such as a subset of client devices 102 used by the recipients. For example, content management system 106 may synchronize the encrypted form of content item 120A (or the encrypted segments of content item 120A) with online-service client application 110E in client device 102B. In this way, the secure, peer-to-peer distributed sharing of the encrypted form of content item 120A may be supplemented using the synchronized online content management system 106.

In some embodiments of process 400, there may be additional or fewer operations. Moreover, the order of the operations may be changed, and/or two or more operations may be combined into a single operation.

In an exemplary embodiment, the secure, peer-to-peer distributed sharing is used to accelerate synchronization among client devices in a synchronized online content management system. In general, synchronizing content items in the synchronized online content management system may be slow because it may only download a given content item from one client device, even when other client devices on the same network have the content item. Moreover, if another client device requests the same content item, the same original client device may respond, so that the synchronized online content management system and the other client device are simultaneously downloading the content item from the client device, which may adversely affect performance.

A solution for this problem is to use secure, peer-to-peer distributed sharing of content items among client devices and/or the synchronized online content management system. For example, SSL-based peer-to-peer distributed sharing (such as BitTorrent from BitTorrent, Inc. of San Francisco, Calif.) may be used by a client device to obtain a content item from multiple other client devices (such as other client devices on the same shared network) to improve performance. More generally, a variety of protocols that enable swarming or peer-to-peer distributed sharing may be used. This approach may be useful for groups users that have significant overlap of content items between accounts, and which use a shared network.

A technique such as BitTorrent over SSL may be useful for applications in which content items are distributed to a closed, but large group of users (such as users in a common entity). Moreover, by using SSL, the publisher of a torrent (such as the user of client device 102A in FIG. 1) can require peers to properly authenticate in the SSL handshake. Furthermore, each peer can verify that all peers they are connected to are allowed onto the swarm by the publisher by making sure they can present an authorization certificate signed by the administrator (for example, a recipient may receive an authorization certificate when the recipient is added to predefined list 124 in FIG. 1). Alternatively or additionally, authorization certificates signed by the publisher may be distributed to the recipients by synchronized online content management system. Note that SSL supports two-way authentication.

The secure, peer-to-peer distributed-sharing technique may dynamically encrypt the content item being shared on the fly (as opposed to distributing a pre-encrypted file). This approach may eliminate the need to make a copy of the content item in order to decrypt it at the end points in the synchronized online content management system. In addition, SSL may be compatible with other authentication techniques, such as: an HTTPS tracker in conjunction with the authentication certificate to authenticate the HTTPS tracker; and/or web seeds.

In an exemplary embodiment, SSL support is implemented in libtorrent. The .torrent file may contain an X.509 certificate from the publisher (such as the user of client device 102A in FIG. 1). The private key part of the certificate may be used to sign peer certificates (such as authorization certificates) to grant them access to the torrent.

If a peer finds an X.509 certificate in the torrent file, it may require a signed certificate from the publisher, and it may require all peers connecting to that torrent to present a valid and signed certificate in the SSL handshake. In particular, the certificate may be signed by the holder of the certificate in the .torrent file, which acts as a root certificate authority (which may be the only root certificate authority), and all the certificates may only use a single hop to the root.

Because a publisher may want to be able to re-use the root certificate for multiple torrents, the CommonName field (or the SubjectAltName field), which typically contains the hostname, may contain either the name of the torrent (e.g., in the ‘name’ field) or ‘* ’ (which indicates that any torrent is acceptable). Peers may honor this by verifying that this field matches when accepting connections. This approach may allow the publisher to use a single cryptographic key, with a single tracker, for multiple torrents, with different access control for each torrent.

Because one peer may participate in multiple torrents, the server name indication (SNI) extension to the transport layer security may be used to indicate the torrent a peer is connecting to. Any outgoing SSL connection may set the SNI field to the hex-encoded information-hash of the torrent (i.e., cryptographic key 122 in FIG. 1). Moreover, because this occurs during the SSL handshake, it may occur before the BitTorrent protocol indicates which information-hash it is using. In the case of SSL, it may be required that the BitTorrent-level information-hash matches the one specified in the SNI field. If the BitTorrent-level information-hash does not match the one specified in the SNI field, the connection may be dropped. Furthermore, if there is no SNI field in an incoming connection, it may be dropped.

If the tracker of an SSL-torrent uses HTTPS, the synchronized online content management system may be expected to present a certificate signed by the same root certificate that is in the .torrent file. This may close the loop to ensure properly authenticated trackers by verifying something in the .torrent file (which is controlled by the publisher). This same criterion may be expected from any web seed with an HTTPS uniform resource locator.

In some embodiments, a BitTorrent over SSL uses the unique and identifying keys each peer has to sign piece requests (or some sort of digital coin or identifier) to prove that a content item was uploaded to a recipient. Using this approach, a tracker may not have to rely on the statistics reported by the client devices.

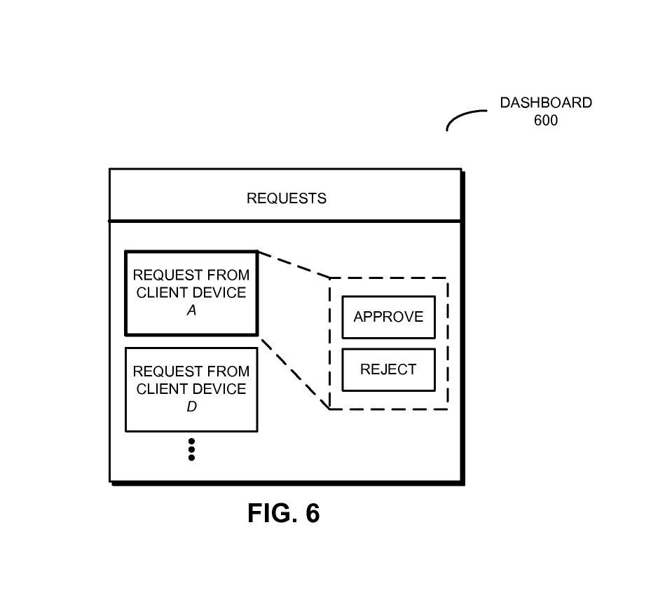

While the preceding examples illustrate the secure, peer-to-peer distributed-sharing process with the cryptographic key generated or selected on the client device where the version of the content item was modified or created, in other embodiments the cryptographic key is generated or selected on the synchronized online content management system and provided to the client device where the version of the content item is modified or created. Moreover, requests for joining predefined list 124 and/or requests for the synchronized online content management system to provide the cryptographic key may be sent to the administrator for approval. FIG. 6 illustrates a dashboard 600 for the administrator that can be used to authorize requests. For example, the administrator can select a particular request (such as that from client device A) by clicking on it, and can either approve it or reject it. Alternatively, the requests may be automatically approved, e.g., if the publisher is in the common entity.

Note that operations in the secure, peer-to-peer distributed sharing may be performed automatically without direct user action. For example, after the user modifies or creates the version of the content item, the client devices and the synchronized online content management system may perform the remaining operations in process 400 (FIG. 4). However, predefined list 124 (FIG. 1) of recipients may be generated manually by the administrator.

While the preceding embodiments illustrated the use of a symmetric cryptographic key, in other embodiments the client device encrypts multiple versions of the modified version of the content item using public encryption keys associated with the recipients. These encrypted versions of the content item may be communicated among at least the subset of the client devices using the secure, peer-to-peer distributed sharing. In these embodiments, the cryptographic key may not be provided to synchronized online content management system. Instead, synchronized online content management system may facilitate sharing of public encryption keys among at least the subset of the client devices.

In the preceding description, we refer to ‘some embodiments.’ Note that ‘some embodiments’ describes a subset of all of the possible embodiments, but does not always specify the same subset of embodiments.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. An electronic-device-implemented method, the method comprising:
using the electronic device, generating a symmetric encryption key associated with a content item;
encrypting the content item using the symmetric encryption key;
encrypting the symmetric encryption key using a public encryption key for a recipient to generate an encrypted symmetric encryption key;
providing the encrypted symmetric encryption keys and information specifying the recipient to a synchronization computer that communicates, via a shared network, with at least one electronic device associated with the recipient; and
communicating the encrypted content item to instances of a client application executing on the at least one electronic device via secure peer-to-peer distributed sharing.

2. The method of claim 1, wherein the content item includes a modification relative to a previous version of the content item; and
wherein the symmetric encryption key is different than a symmetric encryption key used to encrypt the previous version of the content item that was communicated among electronic devices using secure peer-to-peer distributed sharing.

3. The method of claim 1, further comprising:
encrypting the symmetric encryption key using a second public encryption key for a second recipient to generate a second encrypted symmetric encryption key;
providing the second encrypted symmetric encryption key and information specifying the second recipient to a synchronization computer that communicates, via a shared network, with at least one electronic device associated with the second recipient; and
communicating the encrypted content item to instances of the client application executing on the at least one electronic device associated with the second recipient via secure peer-to-peer distributed sharing.

4. The method of claim 3, wherein the recipient and the second recipient are included within a common entity.

5. The method of claim 1, wherein, prior to encrypting the content item, the method further comprises dividing the content item into segments; and
wherein the segments are encrypted using the symmetric encryption key and are communicated using secure peer-to-peer distributed sharing.

6. The method of claim 1, wherein the recipient is specified by a predefined list; and
wherein, prior to encrypting the symmetric encryption key using the public encryption key for the recipient, the method further comprises accessing the predefined list to identify the recipient and the recipient's associated public encryption key.

7. The method of claim 1, wherein the secure peer-to-peer distribution involves a cryptographic protocol between an application layer and a transport layer.

8. A computer-program product comprising a non-transitory computer-readable storage medium and a computer-program mechanism embedded therein, the computer-program mechanism including:
instructions for obtaining a predetermined symmetric encryption key associated with a content item;
instructions for encrypting the content item using the symmetric encryption key;
instructions for encrypting the symmetric encryption key using at least one encryption key for at least one recipient to generate at least one encrypted symmetric encryption key;
instructions for providing the at least one encrypted symmetric encryption key and information specifying the at least one recipient to a synchronization computer that communicates, via a shared network, with electronic devices associated with the at least one recipient; and
instructions for communicating the encrypted content item to instances of a client application executing on the at least one electronic device via secure peer-to-peer distributed sharing.

9. The computer-program product of claim 8, wherein the content item includes a modification relative to a previous version of the content item; and
wherein the symmetric encryption key is different than a symmetric encryption key used to encrypt the previous version of the content item that was communicated using secure peer-to-peer distributed sharing.

10. The computer-program product of claim 8, wherein the computer-program mechanism further includes instructions for:
encrypting the symmetric encryption key using a second public encryption key for a second recipient to generate a second encrypted symmetric encryption key;
providing the second encrypted symmetric encryption key and information specifying the second recipient to a synchronization computer that communicates, via a shared network, with at least one electronic device associated with the second recipient; and
communicating the encrypted content item to instances of the client application executing on the at least one electronic device associated with the second recipient via secure peer-to-peer distributed sharing.

11. The computer-program product of claim 10, wherein the recipient and the second recipient are included within a common entity.

12. The computer-program product of claim 8, wherein, prior to the instructions for encrypting the content item, the computer-program mechanism further includes instructions for dividing the content item into segments; and
wherein the segments are encrypted using the symmetric encryption key and are communicated using secure peer-to-peer distributed sharing.

13. The computer-program product of claim 8, wherein the at least one recipient is specified by a predefined list; and
wherein, prior to the instructions for encrypting the symmetric encryption key using the at least one public encryption key for the at least one recipient, the computer-program mechanism further includes instructions for accessing the predefined list to identify the at least one recipient and the at least one recipient's associated public encryption key.

14. A computer system, comprising:
a processor;
memory; and
a program module, wherein the program module is stored in the memory and configurable to be executed by the processor, the program module including:
instructions for accessing a predetermined symmetric encryption key associated with a content item on the computer system;
instructions for encrypting the content item using the symmetric encryption key;
instructions for encrypting the symmetric encryption key using a public encryption key for a recipient to generate an encrypted symmetric encryption key;
instructions for providing the encrypted symmetric encryption key and information specifying the recipient to a synchronization computer that communicates, via a shared network, with at least one electronic device associated with the recipient; and
instructions for communicating the encrypted content item to instances of the client application executing on the at least one electronic device via secure peer-to-peer distributed sharing.

15. The computer system of claim 14, wherein the content item includes a modification relative to a previous version of the content item; and
wherein the symmetric encryption key is different than a symmetric encryption key used to encrypt the previous version of the content item that was communicated using secure peer-to-peer distributed sharing

16. The computer system of claim 14, wherein the program module further includes instructions for:
encrypting the symmetric encryption key using a second public encryption key for a second recipient to generate a second encrypted symmetric encryption key;
providing the second encrypted symmetric encryption key and information specifying the second recipient to a synchronization computer that communicates, via a shared network, with at least one electronic device associated with the second recipient; and
communicating the encrypted content item to instances of the client application executing on the at least one electronic device associated with the second recipient via secure peer-to-peer distributed sharing.

17. The computer system of claim 16, wherein the recipient and the second recipient are included within a common entity.

18. The computer system of claim 14, wherein, prior to the instructions for encrypting the content item, the program module further includes instructions for dividing the content item into segments; and
wherein the segments are encrypted using the symmetric encryption key and are communicated using secure peer-to-peer distributed sharing.

19. The computer system of claim 14, wherein the secure peer-to-peer distribution involves a cryptographic protocol between an application layer and a transport layer.

20. The computer system of claim 14, wherein the at least one recipient is specified by a predefined list; and
wherein, prior to the instructions for encrypting the symmetric encryption key using the public encryption key for the recipient, the program module further includes instructions for accessing the predefined list to identify the recipient and the recipient's associated public encryption key.
